(19) United States
(12) Patent Application Publication
(10) Pub. No.: US 2005/0003872 A1
(43) Pub. Date: Jan. 6, 2005

(54) Wireless node with antenna detachability

(75) Inventor: Patrick Rada, San Jose, CA (US)

Correspondence Address: WILSON SONSINI GOODRICH & ROSATI, 650 PAGE MILL ROAD, PALO ALTO, CA, 943041050, US

(73) Assignee: NetGear Inc., Santa Clara, CA (US)

(21) Appl. No.: 10/462,101

(22) Filed: Jun. 13, 2003

(51) Int. Cl. H04B 1/46

(52) U.S. Cl. 455/575.7; 455/562.1; 455/63.4; 455/82

(57) ABSTRACT

Disclosed is a wireless node with antenna detachability. Various wireless node configurations allow the 802.11a antenna element and/or the 802.11b/g element to be detached from the base unit.

### BACKGROUND OF THE INVENTION

The 802.11a physical layer may support wireless communication at rates of up to 54 Mbps in the 5 GHz band. The 802.11a 5 GHz band is divided into a lower band of 5.15-5.25 GHz, a middle band of 5.25-5.35 GHz, and an upper band of 5.725-5.825 GHz.

The 802.11b physical layer may support wireless communication at rates of up to 11 Mbps in the 2.4 GHz band. The 802.11g physical layer may support wireless communication at rates of up to 54 Mbps in the 2.4 GHz band.

Operating in any channel of any band can be considered operating in that band.

Advantageous flexibility would be provided by a wireless node having an external, detachable antenna for 802.11a and/or 802.11b/g communications. For example, the antenna could be relocated in a better location. Various antennas could be used with the wireless node, such as an omnidirectional antenna or a directional antenna. Additionally, electronics could be separated from antenna. A dual band antenna refers generally to the 2.4 GHz band and the lower and middle 802.11a bands. A triband antenna refers generally to the 2.4 GHz band and all 802.11a bands.

Thus, it would be desirable if a wireless node could support antenna detachability for 802.11a and/or 802.11b/g communications.

### BRIEF SUMMARY OF THE INVENTION

Some embodiments include a base unit. The base unit includes an antenna connection point and 802.11 circuitry. The antenna connection point is detachably coupleable to an 802.11a antenna element. The 802.11 circuitry includes 802.11a circuitry. The base unit may include other circuitry as well, such as Bluetooth circuitry, GPRS circuitry, UWB circuitry, and/or other circuitry. Detachably coupling the 802.11a antenna element to the antenna connection point permits the wireless node to have 802.11a communications.

Some embodiments include a base unit. The base unit includes an antenna connection point and 802.11 circuitry. The antenna connection point is detachably coupleable to an 802.11a antenna element, and at least one of an 802.11b antenna element and an 802.11g antenna element. The 802.11 circuitry includes 802.11a circuitry, and at least one of 802.11b circuitry and 802.11g circuitry. Detachably coupling the 802.11a antenna element, and at least one of the 802.11b antenna element and the 802.11g antenna element, to the antenna connection point permits the wireless node to have 802.11a communications, and at least one of 802.11b communications and 802.11g communications.

Some embodiments include a base unit and an antenna. The base unit includes a first antenna connection point, a second antenna connection point, and 802.11 circuitry. The first antenna connection point is nondetachably coupled to an 802.11a antenna element. The second antenna connection point is detachably coupleable to at least one of an 802.11b antenna element and an 802.11g antenna element. The 802.11 circuitry includes 802.11a circuitry and at least one of 802.11b circuitry and 802.11g circuitry. The antenna includes the 802.11a antenna element nondetachably coupled to the first antenna connection point. The 802.11a antenna element permits the wireless node to have at least 802.11a communications. Detachably coupling at least one of the 802.11b antenna element and the 802.11g antenna element to the second antenna connection point permits the wireless node to have at least one of 802.11b communications and 802.11g communications

### BRIEF DESCRIPTION OF THE FIGURES

FIG. 1 shows an embodiment of a wireless node.

FIG. 2 shows an embodiment of a wireless node with a base unit nondetachably coupled to an antenna with an 802.11a antenna element.

FIG. 3 shows a particular embodiment of a wireless node nondetachably coupled to an 802.11a antenna element and detachably coupled to an 802.11b/g antenna element.

FIG. 4 shows a particular embodiment of a wireless node detachably coupled to an 802.11a antenna element and an 802.11b/g antenna element, via multiple antenna connection points.

FIG. 5 shows a particular embodiment of a wireless node detachably coupled to an 802.11a antenna element and an 802.11b/g antenna element, via a single antenna connection point.

FIG. 6 shows an example of a custom connector for supporting 802.11a signals and 802.11b/g signals.

FIG. 7 shows a particular embodiment of a wireless node detachably coupled to an 802.11a antenna element.

### DETAILED DESCRIPTION OF THE INVENTION

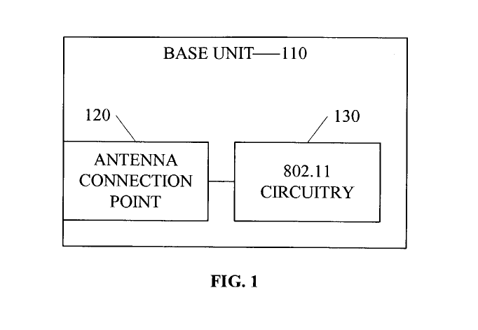

FIG. 1 shows an embodiment of a wireless node. The wireless node may be a bridge, an access point, a router, a gateway, a modem, and/or a client adapter. Some examples of a client adapter are a PC card, a USB device, a PCI card, and/or a mini-PCI card. A base unit 110 includes an antenna connection point 120 and 802.11 circuitry 130. Additional antenna connection points may exist, permitting spatial diversity and/or multiple input multiple output.

In some cases, the 802.11 circuitry 130 can include 802.11a circuitry. The antenna connection point 120 can detachably couple to an 802.11a antenna element. Detachably coupling the 802.11a antenna element to the antenna connection point permits the wireless node to have 802.11a communications.

Antenna elements can radiate and/or receive in the relevant band(s), and may also operate in other frequencies. Some embodiments of the antenna include multiple separate antenna elements, such as for transmitting and/or receiving in various frequency bands. Some embodiments of the antenna include a merged antenna element, which can transmit and/or receive in one or more frequency bands. The antenna can be directly coupled to the base unit, or remotely coupled to the base unit, e.g. via cable.

The base unit 110 may also include a second antenna connection point. The second antenna connection point is detachably coupleable to an 802.11b antenna element and/or 802.11g antenna element. The 802.11 circuitry 130 can also include 802.11b circuitry and/or 802.11g circuitry. Detachably coupling the 802.11b antenna element and/or the 802.11g antenna element to the second antenna connection point permits the wireless node to have 802.11b communications and/or 802.11g communications.

The 802.11a antenna element, 802.11b antenna element, and/or the 802.11g antenna element can be in one, two, or more antennas.

In some cases, the 802.11 circuitry 130 can include 802.11a circuitry, 802.11b circuitry, and/or 802.11g circuitry. The antenna connection point 120 can detachably couple to an 802.11a antenna element, an 802.11b antenna element, and/or 802.11g antenna element. Detachably coupling the 802.11a antenna element, the 802.11b antenna element, and/or the 802.11g antenna element to the first antenna connection point permits the wireless node to have 802.11a communications, 802.11b communications, and/or 802.11g communications.

The antenna connection points can communicate through one or more conductors, such as pins. If a conductor carries 802.11a signals, 802.11b signals, and/or 802.11g signals, the 802.11a signals can be demultiplexed from the 802.11b signals and/or 802.11g signals.

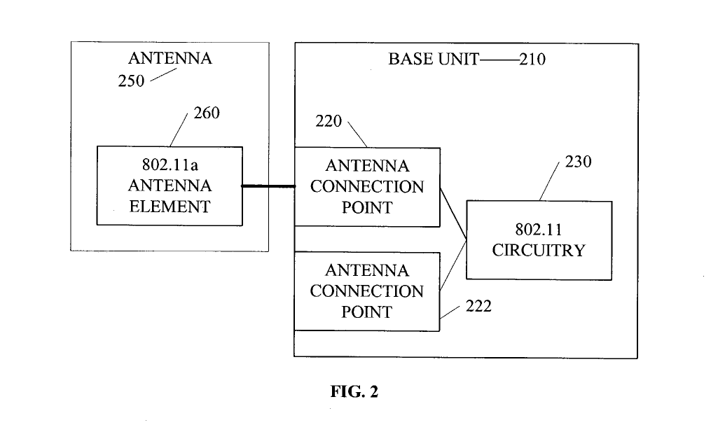

FIG. 2 shows another embodiment of a wireless node. A base unit 210 is nondetachably coupled to an antenna 250. The base unit 210 includes antenna connection points 220 and 222, and 802.11 circuitry 230. Antenna connection point 220 is nondetachably coupled to an 802.11a antenna element 260 in the antenna 250. Additional antenna connection points may exist, permitting spatial diversity and/or multiple input multiple output.

The 802.11a antenna element permits the wireless node to have at least 802.11a communications. Detachably coupling the 802.11b antenna element and/or the 802.11g antenna element to a second antenna connection point permits the wireless node to have 802.11b communications and/or 802.11g communications.

The 802.11a antenna element, the 802.11b antenna element, and/or the 802.11g antenna element can be in one, two, or more antennas.

Some embodiments of the wireless node can provide 802.11a and 802.11g/b at the same time and/or different times.

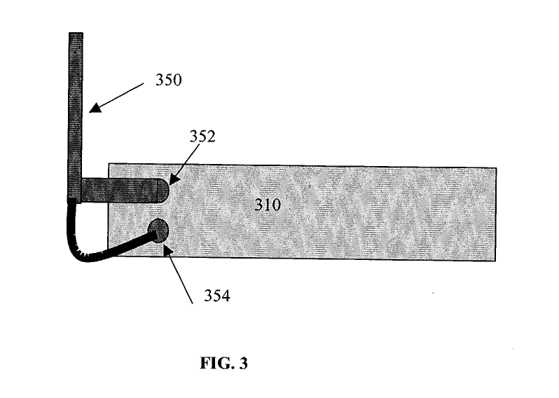

FIG. 3 shows a particular embodiment of a wireless node. A base unit 310 is coupled to an 802.11a/b/g antenna 350. The base unit 310 is nondetachably coupled to an 802.11a antenna element via antenna connection point 352. The base unit 310 is detachably coupled to an 802.11b/g antenna element via antenna connection point 354. The connection can be via a reverse SMA connector. Additional antenna(s) can provide spatial diversity and/or multiple input multiple output.

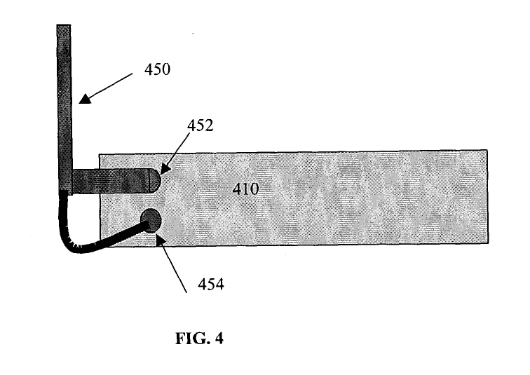

FIG. 4 shows another particular embodiment of a wireless node. A base unit 410 is coupled to an 802.11a/b/g antenna 450. The base unit 410 is detachably coupled to an 802.11a antenna element via antenna connection point 452. The base unit 410 is detachably coupled to an 802.11b/g antenna element via antenna connection point 454. The connections can be via a reverse SMA connector. The connectors can be separate, as shown, or can be integrated into a housing, such that removal of one connector necessitates removing the other connector. Additional antenna(s) can provide spatial diversity and/or multiple input multiple output. Some embodiments block the lower band of 802.11a at all times. Other embodiments selectively allow the lower band of 802.11a, such as when the base unit 410 is coupled to the 802.11a antenna element.

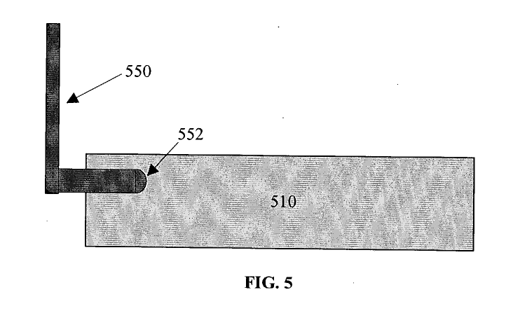

FIG. 5 shows yet another particular embodiment of a wireless node. A base unit 510 is coupled to an 802.11a/b/g antenna 550. The base unit 510 is detachably coupled to an 802.11a antenna element and an 802.11b/g element via antenna connection point 552. The connections can be via a custom connector. Additional antenna(s) can provide spatial diversity and/or multiple input multiple output. Some embodiments block the lower band of 802.11a at all times. Other embodiments selectively allow the lower band of 802.11a, such as when the base unit 510 is coupled to the 802.11a antenna element.

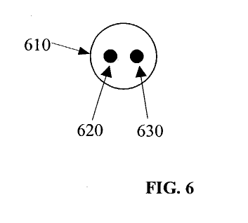

FIG. 6 shows an example of a 50 ohm RF bi-coaxial custom connector 610. In some cases, 802.11a signals can be carried by conductor 620, and 802.11b/g signals can be carried by conductor 630.

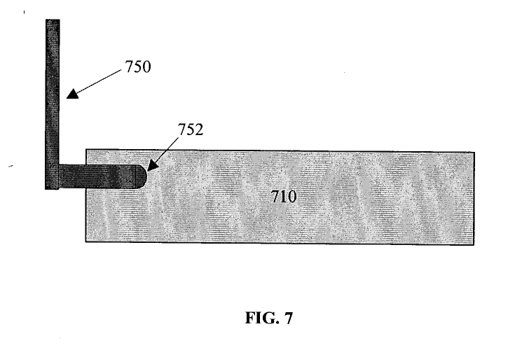

FIG. 7 shows yet another particular embodiment of a wireless node. A base unit 710 is coupled to an 802.11a antenna 750. The base unit 710 is detachably coupled to an 802.11a antenna element via antenna connection point 752. The connections can be via a custom connector. Additional antenna(s) can provide spatial diversity and/or multiple input multiple output. Some embodiments block the lower band of 802.11a at all times. Other embodiments selectively allow the lower band of 802.11a, such as when the base unit 710 is coupled to the 802.11a antenna clement.

1. A wireless node, comprising:
a base unit, including:
a first antenna connection point detachably coupleable to an 802.11a antenna element, and
802.11 circuitry including 802.11a circuitry,
wherein detachably coupling at least the 802.11a antenna element to the first antenna connection point permits the wireless node to have at least 802.11a communications.

2. The node of claim 1, further comprising one or more additional antenna connection points permitting 802.11a communications with spatial diversity.

3. The node of claim 1, further comprising one or more additional antenna connection points permitting 802.11a communications with multiple input multiple output.

4. The node of claim 1, wherein the base unit further comprises a second antenna connection point detachably coupleable to at least one of an 802.11b antenna element and an 802.11g antenna element, the 802.11 circuitry further includes at least one of 802.11b circuitry and 802.11g circuitry, and detachably coupling at least one of the 802.11b antenna element and the 802.11g antenna element to the second antenna connection point permits the wireless node to have at least one of 802.11b communications and 802.11g communications.

5. The node of claim 4, further comprising one or more additional antenna connection points permitting at least one of 802.11b communications with spatial diversity and 802.11g communications with spatial diversity.

6. The node of claim 4, further comprising one or more additional antenna connection points permitting at least one of 802.11b communications with multiple input multiple output and 802.11g communications with multiple input multiple output.

7. The node of claim 4, further comprising:
an antenna including:
the 802.11a antenna element detachably coupleable to the first antenna connection point, and
at least one of the 802.11b antenna element and the 802.11g antenna element, detachably coupleable to the second antenna connection point.

8. The node of claim 7, wherein the 802.11a antenna element and the at least one of the 802.11b antenna element and the 802.11g antenna element are merged.

9. The node of claim 7, wherein the 802.11a antenna element and the at least one of the 802.11b antenna element and the 802.11g antenna element are separate.

10. The node of claim 4, further comprising:
a first antenna including:
the 802.11a antenna element detachably coupleable to the first antenna connection point, and
a second antenna including:
at least one of the 802.11b antenna element and the 802.11g antenna element, detachably coupleable to the second antenna connection point.

11. The node of claim 1, wherein the base unit further comprises a second antenna connection point nondetachably coupled to at least one of an 802.11b antenna element and an 802.11g antenna element, the 802.11 circuitry further includes at least one of 802.11b circuitry and 802.11g circuitry, and at least one of the 802.11b antenna element and the 802.11g antenna element permits the wireless node to have at least one of 802.11b communications and 802.11g communications.

12. The node of claim 11, further comprising one or more additional antenna connection points permitting at least one of 802.11b communications with spatial diversity and 802.11g communications with spatial diversity.

13. The node of claim 11, further comprising one or more additional antenna connection points permitting at least one of 802.11b communications with multiple input multiple output and 802.11g communications with multiple input multiple output.

14. The node of claim 11, further comprising:
an antenna including:
the 802.11a antenna element detachably coupleable to the first antenna connection point, and
at least one of the 802.11b antenna element and the 802.11g antenna element, nondetachably coupled to the second antenna connection point.

15. The node of claim 14, wherein the 802.11a antenna element and the at least one of the 802.11b antenna element and the 802.11g antenna element are merged.

16. The node of claim 14, wherein the 802.11a antenna element and the at least one of the 802.11b antenna element and the 802.11g antenna element are separate.

17. The node of claim 11 further comprising:
a first antenna including:
the 802.11a antenna element detachably coupleable to the first antenna connection point, and
a second antenna including:
at least one of the 802.11b antenna element and the 802.11g antenna element, nondetachably coupled to the second antenna connection point.

18. The node of claim 1, wherein the wireless node includes an access point.

19. The node of claim 1, wherein the wireless node includes a router.

20. The node of claim 1, wherein the wireless node includes a gateway.

21. The node of claim 1, wherein the wireless node includes a modem.

22. The node of claim 1, wherein the wireless node includes a client adapter.

23. The node of claim 1, wherein the wireless node includes a bridge.

24. The node of claim 1, further comprising:
an antenna including:
the 802.11a antenna element detachably coupleable to the first antenna connection point.

25. A wireless node, comprising:
a base unit, including:
a first antenna connection point detachably coupleable to at least: an 802.11a antenna element, and at least one of the 802.11b antenna element and the 802.11g antenna element, and
802.11 circuitry including 802.11a circuitry and at least one of 802.11b circuitry and 802.11g circuitry,
wherein detachably coupling the 802.11a antenna element, and at least one of the 802.11b antenna element and the 802.11g antenna element, to the first antenna connection point permits the wireless node to have at least 802.11a communications, and at least one of 802.11b communications and 802.11g communications.

26. The node of claim 25, further comprising one or more additional antenna connection points permitting at least one of 802.11a communications with spatial diversity, 802.11b communications with spatial diversity, and 802.11g communications with spatial diversity.

27. The node of claim 25, further comprising one or more additional antenna connection points permitting at least one of 802.11a communications with multiple input multiple output, 802.11b communications with multiple input multiple output, and 802.11g communications with multiple input multiple output.

28. The node of claim 25, wherein the first antenna connection point communicates through a plurality of conductors.

29. The node of claim 28, wherein a first conductor of the plurality of conductors communicates 802.11a signals, and a second conductor of the plurality of conductors communicates at least one of 802.11b signals and 802.11g signals.

30. The node of claim 25 wherein the first antenna connection point communicates through one conductor.

31. The node of claim 30, wherein the one conductor communicates 802.11a signals and at least one of 802.11b signals and 802.11g signals.

32. The node of claim 25, further comprising:
an antenna including:
the 802.11a antenna element detachably coupleable to the first antenna connection point, and
at least one of the 802.11b antenna element and the 802.11g antenna element, detachably coupleable to the first antenna connection point.

33. The node of claim 32, wherein the 802.11a antenna element and the at least one of the 802.11b antenna element and the 802.11g antenna element are merged.

34. The node of claim 32, wherein the 802.11a antenna element and the at least one of the 802.11b antenna element and the 802.11g antenna element are separate.

35. The node of claim 25, wherein the wireless node includes an access point.

36. The node of claim 25, wherein the wireless node includes a router.

37. The node of claim 25, wherein the wireless node includes a gateway.

38. The node of claim 25, wherein the wireless node includes a modem.

39. The node of claim 25, wherein the wireless node includes a client adapter.

40. The node of claim 25, wherein the wireless node includes a bridge.

41. A wireless node, comprising:
a base unit, including:
a first antenna connection point nondetachably coupled to an 802.11a antenna element,
a second antenna connection point detachably coupleable to at least one of an 802.11b antenna element and an 802.11g antenna element, and
802.11 circuitry including 802.11a circuitry and at least one of 802.11b circuitry and 802.11g circuitry, and
a first antenna including:
the 802.11a antenna element nondetachably coupled to the first antenna connection point,
wherein the 802.11a antenna element permits the wireless node to have at least 802.11a communications, and detachably coupling at least one of the 802.11b antenna element and the 802.11g antenna element to the second antenna connection point permits the wireless node to have at least one of 802.11b communications and 802.11g communications.

42. The node of claim 41, further comprising one or more additional antenna connection points permitting at least one of 802.11a communications with spatial diversity, 802.11b communications with spatial diversity, and 802.11g communications with spatial diversity.

43. The node of claim 41, further comprising one or more additional antenna connection points permitting at least one of 802.11a communications with multiple input multiple output, 802.11b communications with multiple input multiple output, and 802.11g communications with multiple input multiple output.

44. The node of claim 41, further comprising:
a second antenna including:
at least one of the 802.11b antenna element and the 802.11g antenna element, detachably coupleable to the second antenna connection point.

45. The node of claim 41, wherein the first antenna further includes at least one of the 802.11b antenna element and the 802.11g antenna element, detachably coupleable to the second antenna connection point.

46. The node of claim 45, wherein the 802.11a antenna element and the at least one of the 802.11b antenna element and the 802.11g antenna element are merged.

47. The node of claim 45, wherein the 802.11a antenna element and the at least one of the 802.11b antenna element and the 802.11g antenna element are separate.

48. The node of claim 41, wherein the wireless node includes an access point.

49. The node of claim 41, wherein the wireless node includes a router.

50. The node of claim 41, wherein the wireless node includes a gateway.

51. The node of claim 41, wherein the wireless node includes a modem.

52. The node of claim 41, wherein the wireless node includes a client adapter.

53. The node of claim 41, wherein the wireless node includes a bridge.
